(19) United States
(12) Patent Application Publication
(10) Pub. No.: US 2025/0188784 A1
(43) Pub. Date: Jun. 12, 2025

(54) 360-DEGREE ROTATIONAL CAM HYDRAULIC DOOR CLOSER FOR NARROW FRAME DOOR

(71) Applicant: SUN-Q DOOR CONTROLS LIMITED, YUANLIN CITY (TW)

(72) Inventor: Tsung-Ching CHEN, YUANLIN CITY (TW)

(21) Appl. No.: 18/976,739

(22) Filed: Dec. 11, 2024

(30) Foreign Application Priority Data
Dec. 11, 2023 (CN) 202323370034.3

(51) Int. Cl. E05F 3/10; E05F 3/12; E05F 15/50; E06B 3/90

(52) U.S. Cl. CPC E05F 3/104; E05F 3/12; E05F 15/50; E06B 3/90; E05Y 2201/212; E05Y 2201/47; E05Y 2201/638; E05Y 2800/12; E05Y 2800/422

(57) ABSTRACT

The present invention relates to a 360-degree rotational cam hydraulic door closer for a narrow frame door. The cam shaft is 360-degree rotatably supported in the door closer housing. The matching of the damping roller rotationally disposed on the bidirectional piston with left and right closing arc recesses on the outer peripheral surface of the eccentric cam keeps a closed status when the door is rotated to 0°, 180° and 360°, wherein the damping roller is embedded in the left or right closing arc recess, fixed relative to the eccentric cam, achieving door angle fixing and door stopping. The cam shaft receives the damping effect generated from the damping roller to the eccentric cam, that lowers the transient door opening and closing speed, achieving sufficient buffering. The open angle of 0°-360° is realized, which meets revolving doors' requirement, facilitating the door to be opened to both sides.

### BACKGROUND OF THE INVENTION

### 1. Field of the Invention

The present invention belongs to the technical field of door closers, and particularly relates to a 360-degree rotational cam hydraulic door closer for a narrow frame door.

### 2. Description of the Related Art

A door closer is a spring-like hydraulic device on the door head. After the door is opened, the door closer can be compressed and then released to automatically close the door. It acts like a spring door, and can ensure that after the door is opened, the door closes accurately and promptly to the initial position.

During the spring release process of the door closer, the hydraulic oil in the left chamber of the door closer is compressed, and the one-way valve is closed. The hydraulic oil can only flow out through the gap between the door closer housing and the plunger, and flow back to the right chamber through the small hole on the plunger and two flow channels equipped with throttle valve cores. Therefore, the hydraulic oil constitutes resistance to the spring release. That is, buffering effect is achieved through throttling, so that the door closing speed is controlled.

Most of the common door closers can only allow the door to be opened to 90 degrees, and a few can allow the door to be opened to 180 degrees. Therefore, in some situations where the door needs to be opened and closed for more than 180 degrees, the aforementioned door closers are all inapplicable, relatively narrow in application scope. The aforementioned door closers cannot be applied to the door accessible from both sides, limited in usage.

### SUMMARY OF THE INVENTION

It is an objective of the present invention to provide a 360-degree rotational cam hydraulic door closer for a narrow frame door, which can solve the technical problem in the existing technology that the door closer has relatively narrow application scope, inapplicable to the door accessible from both sides.

To attain the above objective, the embodiment of the present invention provides a 360-degree rotational cam hydraulic door closer for a narrow frame door, which includes:
a door closer housing, the door closer housing being provided therein along the axis direction thereof with an inner chamber;
a cam shaft, the axial direction of the cam shaft being perpendicular to the extending direction of the door closer housing, the cam shaft being 360-degree rotatably supported in the door closer housing, the cam shaft being equipped at the middle part thereof with an eccentric cam rotating simultaneously with the cam shaft;
a bidirectional piston, the bidirectional piston being slidingly disposed in the inner chamber and located at the right side of the eccentric cam, a damping roller being rotationally disposed at a side of the bidirectional piston close to the eccentric cam; and
a drive spring, the drive spring being accommodated in the inner chamber and abutted against the bidirectional piston and the door closer housing, the drive spring driving the damping roller to be consistently flexibly abutted against the outer peripheral surface of the eccentric cam;
wherein the outer peripheral surface of the eccentric cam is provided clockwise in order with a left closing arc recess, an upper damping protrusion, a right closing arc recess and a lower damping protrusion; the left closing arc recess and the right closing arc recess are located on a same horizontal line; the upper damping protrusion and the lower damping protrusion are located on a same vertical line.

Optionally, the bidirectional piston is equipped at the side thereof close to the eccentric cam with a fixed pin; the damping roller is rotationally installed on the fixed pin.

Optionally, the drive spring includes an inner spring and an outer spring; the outer spring is sleeved outside the inner spring; an end of the outer spring and the inner spring are abutted against the door closer housing at the same time; another end of the outer spring and the inner spring are abutted against the bidirectional piston at the same time.

Optionally, the door closer housing is equipped with a first bushing correspondingly to the lower end of the cam shaft; the door closer housing is equipped with a positionally limiting installation seat correspondingly to the upper end of the cam shaft, and at the same time the positionally limiting installation seat is equipped with a second bushing; the midpoints of the first bushing and the second bushing are located on a same axis; the cam shaft is inserted in the first bushing and the second bushing.

Optionally, an outer sealing ring is disposed between the outer end surface of the positionally limiting installation seat and the door closer housing; an inner sealing ring is disposed between the inner end surface of the positionally limiting installation seat and the cam shaft.

Optionally, the door closer housing includes:
a housing main body, the housing main body being hollow inside and having two lateral openings, the cam shaft being pivoted to the housing main body; and
two sealing end caps, the two sealing end caps being fixedly disposed on the two lateral openings of the housing main body respectively to form the inner chamber in an enclosed manner, an end cap sealing ring being disposed between the outer end surface of the sealing end cap and the housing main body.

Optionally, the 360-degree rotational cam hydraulic door closer for the narrow frame door further includes an automatic compensation valve assembly slidingly disposed in the inner chamber and located at the left side of the eccentric cam; the automatic compensation valve assembly and the bidirectional piston collectively partition the inner chamber into a first oil channel located at the left side of the automatic compensation valve assembly, a second oil channel located at the right side of the bidirectional piston, and a third oil channel located between the automatic compensation valve assembly and the bidirectional piston; the first oil channel, the second oil channel and the third oil channel are all filled with hydraulic oil; the hydraulic oil flows between the second oil channel and the third oil channel through the bidirectional piston, and the automatic compensation valve assembly is configured in a way that if the pressure in the first oil channel exceeds a threshold pressure, the automatic compensation valve assembly allows the hydraulic oil to flow between the first oil channel and the third oil channel.

Optionally, the automatic compensation valve assembly includes:
a valve piston, the valve piston being slidingly disposed in the inner chamber;
a valve body, the valve body being installed in the valve piston, at the same time the valve body being provided therethrough with a valve flow channel communicating with the first oil channel and the third oil channel;
a valve core member, the valve core member being movably disposed in the valve flow channel for realizing the open or shut of the valve flow channel; and
a valve core spring, the valve core spring being accommodated in the valve flow channel, an end of the valve core spring being connected with the valve body, another end of the valve core spring being connected with the valve core member for driving the valve core member to shut off the valve flow channel.

The above-described one or a plurality of technical scenarios of the 360-degree rotational cam hydraulic door closer for the narrow frame door provided by the embodiment of the present invention at least has one of the following technical effects. The 360-degree rotational cam hydraulic door closer for the narrow frame door is novel in structure. The cam shaft is 360-degree rotatably supported in the door closer housing. By the matching of the damping roller rotationally disposed on the bidirectional piston with the left closing arc recess and the right closing arc recess provided on the outer peripheral surface of the eccentric cam, keeping a closed status when the door is rotated to 0 degree, 180 degrees and 360 degrees is realized. In this status, the damping roller is embedded in the left closing arc recess or the right closing arc recess, thereby fixed relative to the eccentric cam. Thus, the cam shaft is stopped from continuing rotating in the door closer housing, thereby achieving the effect of fixing the door opening and closing angle, at last achieving the purpose of positionally stopping the door. At the same time, the cam shaft receives the damping effect generated from the damping roller to the eccentric cam during the rotation of the door closer housing, that lowers the transient door opening and closing speed, thereby achieving sufficient buffering. It can be seen that the present invention realizes the open angle from 0 degree to 360 degrees, which meets the usage requirement of revolving doors, facilitating the door to be opened to both sides.

### BRIEF DESCRIPTION OF THE DRAWINGS

In order to more clearly illustrate the technical scenarios in the embodiment of the present invention, the accompanying figures that need to be used in the description of the embodiment or the prior art will be briefly introduced below. Obviously, the accompanying figures in the following description are only some embodiments of the present invention. For those skilled in this field, other figures can be obtained based on these figures without exerting creative effort.

FIG. 1 is a first schematic view of the internal structure of the 360-degree rotational cam hydraulic door closer for the narrow frame door provided by the embodiment of the present invention.

FIG. 2 is a second schematic view of the internal structure of the 360-degree rotational cam hydraulic door closer for the narrow frame door provided by the embodiment of the present invention.

FIG. 3 is a schematic view of the structure of the eccentric cam provided by the embodiment of the present invention.

FIG. 4 is a schematic view of the structure of the door closer housing provided by the embodiment of the present invention.

FIG. 5 is a schematic view of the structure of the automatic compensation valve assembly provided by the embodiment of the present invention.

### DETAILED DESCRIPTION OF THE INVENTION

Embodiments of the present invention are described in detail below. The embodiments are illustrated in the accompanying figures, wherein same or similar reference numerals throughout represent same or similar elements or elements with same or similar functions. The following embodiments described with reference to the accompanying figures are illustrative, intended to explain the embodiments of the present invention, and cannot be understood as limitations of the present invention.

In the description of the embodiments of the present invention, it should be understood that the orientation or positional relationship indicated by the terms ‘length’, ‘width’, ‘upper’, ‘lower’, ‘front’, ‘rear’, ‘left’, ‘right’, ‘vertical’, ‘horizontal’, ‘top’, ‘bottom’, ‘inner’, ‘outer’, and so on are on the basis of the orientation or positional relationship shown in the accompanying figures, just for the convenience of describing the embodiments of the present invention and simplifying the description, not indicating or implying the mentioned device or element should have the specific orientation or be composed and operated with the specific orientation, and thereby cannot be understood as limitations of the present invention.

Besides, the terms ‘first’ and ‘second’ are used for the descriptive purpose only, and cannot be understood as indicating or implying the relative importance or implying specific amount of the mentioned technical feature. Thus, features prescribed with ‘first’ and ‘second’ may explicitly or implicitly include one or more the features. In the description of the embodiments of the present invention, ‘a plurality of’ means two or more than two, unless there is additional explicit and specific limitation.

In the embodiments of the present invention, unless there is additional explicit provision and limitation, the terms ‘install’, ‘link’, ‘connect’, ‘fix’, and so on should be understood broadly. For example, they may refer to fixed connection, or may refer to detachable connection, or being an integral; they may refer to mechanical connection, or may refer to electrical connection; they may refer to direct connection, or indirect connection through intermedium, or may refer to inner communication between two elements or interaction between two elements. For those skilled in this field, the specific meanings of the aforementioned terms in the embodiments of the present invention can be understood according to specific conditions.

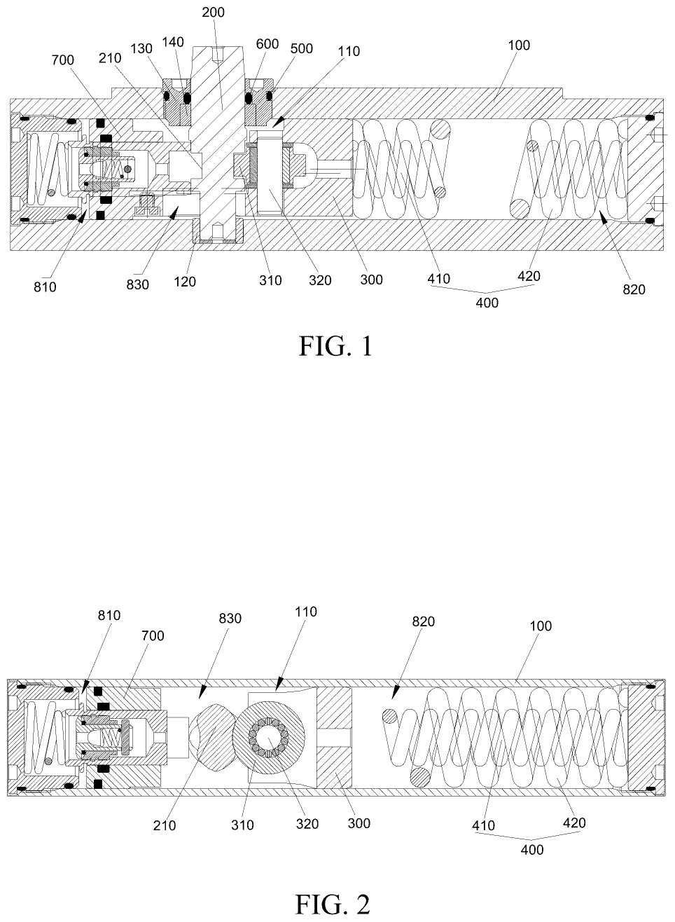

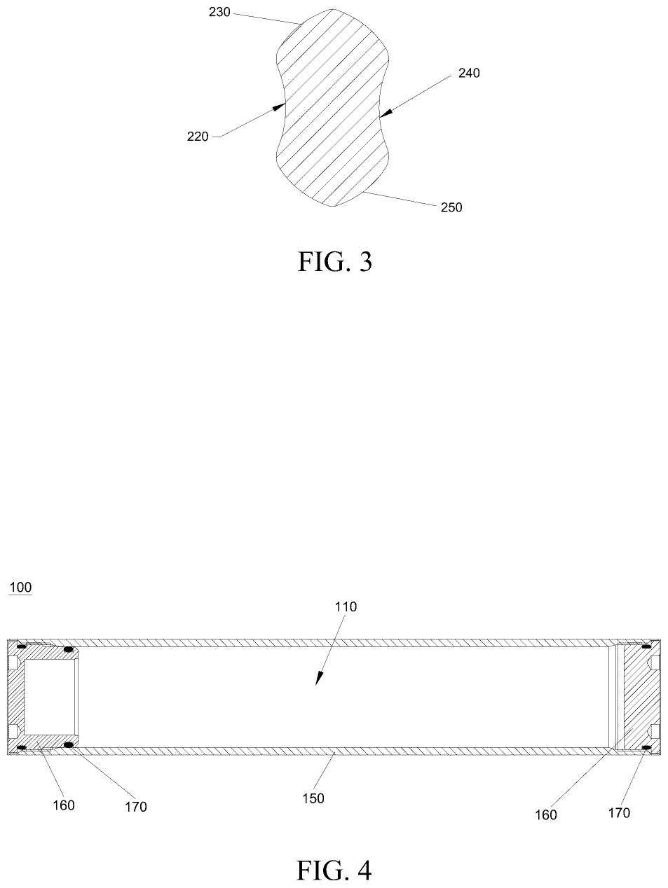

In a first embodiment of the present invention, as shown in FIGS. 1-3, a 360-degree rotational cam hydraulic door closer for a narrow frame door is provided, which includes:
a door closer housing 100, the door closer housing 100 being provided therein along the axis direction thereof with an inner chamber 110;
a cam shaft 200, the axial direction of the cam shaft 200 being perpendicular to the extending direction of the door closer housing 100, the cam shaft 200 being 360-degree rotatably supported in the door closer housing 100, the cam shaft 200 being equipped at the middle part thereof with an eccentric cam 210 rotating simultaneously with the cam shaft 200;
a bidirectional piston 300, the bidirectional piston 300 being slidingly disposed in the inner chamber 110 and located at the right side of the eccentric cam 210, a damping roller 310 being rotationally disposed at a side of the bidirectional piston 300 close to the eccentric cam 210 with; and
a drive spring 400, the drive spring 400 being accommodated in the inner chamber 110 and abutted against the bidirectional piston 300 and the door closer housing 100, the drive spring 400 driving the damping roller 310 to be consistently flexibly abutted against the outer peripheral surface of the eccentric cam 210;
wherein the outer peripheral surface of the eccentric cam 210 is provided clockwise in order with a left closing arc recess 220, an upper damping protrusion 230, a right closing arc recess 240 and a lower damping protrusion 250; the left closing arc recess 220 and the right closing arc recess 240 are located on a same horizontal line; the upper damping protrusion 230 and the lower damping protrusion 250 are located on a same vertical line.

Specifically, in this embodiment, the 360-degree rotational cam hydraulic door closer for the narrow frame door is novel in structure. The cam shaft 200 is 360-degree rotatably supported in the door closer housing 100. By the matching of the damping roller 310 rotationally disposed on the bidirectional piston 300 with the left closing arc recess 220 and the right closing arc recess 240 provided on the outer peripheral surface of the eccentric cam 210, keeping a closed status when the door is rotated to 0 degree, 180 degrees and 360 degrees is realized. In this status, the damping roller 310 is embedded in the left closing arc recess 220 or the right closing arc recess 240, thereby fixed relative to the eccentric cam 210. Thus, the cam shaft 200 is stopped from continuing rotating in the door closer housing 100, thereby achieving the effect of fixing the door opening and closing angle, at last achieving the purpose of positionally stopping the door. At the same time, the cam shaft 200 receives the damping effect generated from the damping roller 310 to the eccentric cam 210 during the rotation of the door closer housing 100, that lowers the transient door opening and closing speed, thereby achieving sufficient buffering. It can be seen that the present invention realizes the open angle from 0 degree to 360 degrees, which meets the usage requirement of revolving doors, facilitating the door to be opened to both sides.

In a second embodiment of the present invention, as shown in FIGS. 1-3, the bidirectional piston 300 is equipped at the side thereof close to the eccentric cam 210 with a fixed pin 320. The damping roller 310 is rotationally installed on the fixed pin 320.

Specifically, in this embodiment, the damping roller 310 is rotationally installed on the bidirectional piston 300 through the fixed pin 320, that makes the installation and detachment of the damping roller 310 convenient, facilitating the maintenance and replacement of the damping roller 310.

The other parts of this embodiment are the same with the first embodiment. The features unexplained in this embodiment all adopt the explanation in the first embodiment, not repeatedly described here.

In a third embodiment of the present invention, as shown in FIGS. 1-2, the drive spring 400 includes an inner spring 410 and an outer spring 420. The outer spring 420 is sleeved outside the inner spring 410. An end of the outer spring 420 and the inner spring 410 are abutted against the door closer housing 100 at the same time. Another end of the outer spring 420 and the inner spring 410 are abutted against the bidirectional piston 300 at the same time.

Specifically, in this embodiment, the drive spring 400 has simple structure and reasonable design. When the drive spring 400 receives a force and be lengthened or shortened, the inner spring 410 and the outer spring 420 are both correspondingly lengthened or shortened without interference with each other. Therefore, the inner spring 410 and the outer spring 420 are uneasy to be deformed when used together, effectively raising the service life of the inner spring 410 and the outer spring 420. The composite design highly increases the elasticity of the drive spring 400, ensuring the perpendicular stability of the spring force and effectively preventing the inner spring 410 and the outer spring 420 from damage due to excessive load.

The other parts of this embodiment are the same with the first embodiment. The features unexplained in this embodiment all adopt the explanation in the first embodiment, not repeatedly described here.

In a fourth embodiment of the present invention, as shown in FIG. 1, the door closer housing 100 is equipped with a first bushing 120 correspondingly to the lower end of the cam shaft 200. The door closer housing 100 is equipped with a positionally limiting installation seat 130 correspondingly to the upper end of the cam shaft 200, and at the same time the positionally limiting installation seat 130 is equipped with a second bushing 140. The midpoints of the first bushing 120 and the second bushing 140 are located on a same axis. The cam shaft 200 is inserted in the first bushing 120 and the second bushing 140.

Specifically, in this embodiment, the primary function of the first bushing 120 and the second bushing 140 is to fix the cam shaft 200. During the motion of the cam shaft 200, the first bushing 120 and the second bushing 140 generate the vibration reducing effect, and can help the cam shaft 200 to stay balanced and stable, and at the same time can also reduce friction and wear, increasing the service life of the cam shaft 200.

The other parts of this embodiment are the same with the first embodiment. The features unexplained in this embodiment all adopt the explanation in the first embodiment, not repeatedly described here.

In a fifth embodiment of the present invention, as shown in FIG. 1, an outer sealing ring 500 is disposed between the outer end surface of the positionally limiting installation seat 130 and the door closer housing 100. An inner sealing ring 600 is disposed between the inner end surface of the positionally limiting installation seat 130 and the cam shaft 200.

Specifically, in this embodiment, in one aspect, the outer sealing ring 500 is consistently kept being tightly abutted against the outer end surface of the positionally limiting installation seat 130 and the door closer housing 100, so that it can be sealed between the positionally limiting installation seat 130 and the door closer housing 100 by the outer sealing ring 500. In another aspect, the inner sealing ring 600 is consistently kept being tightly abutted against the inner end surface of the positionally limiting installation seat 130 and the cam shaft 200, so that it can be sealed between the positionally limiting installation seat 130 and the cam shaft 200 by the inner sealing ring 600.

The other parts of this embodiment are the same with the fourth embodiment. The features unexplained in this embodiment all adopt the explanation in the fourth embodiment, not repeatedly described here.

In a sixth embodiment of the present invention, as shown in FIG. 4, the door closer housing 100 includes:
a housing main body 150, the housing main body 150 being hollow inside and having two lateral openings, the cam shaft 200 being pivoted to the housing main body 150; and
two sealing end caps 160, the two sealing end caps 160 being fixedly disposed on the two lateral openings of the housing main body 150 respectively to form the inner chamber 110 in an enclosed manner, an end cap sealing ring 170 being disposed between the outer end surface of the sealing end cap 160 and the housing main body 150.

Specifically, in this embodiment, the housing main body 150 and the two sealing end caps 160 of the door closer housing 100 are detachably connected. In one aspect, the operation of maintaining the whole 360-degree rotational cam hydraulic door closer for the narrow frame door is greatly simplified. The operator can do the disassembly and maintenance quickly and conveniently. In another aspect, the detachable structure facilitates the maintenance and replacement of the single housing main body 150 or sealing end cap 160, thereby lowering the maintenance cost.

The other parts of this embodiment are the same with the first embodiment. The features unexplained in this embodiment all adopt the explanation in the first embodiment, not repeatedly described here.

In a seventh embodiment of the present invention, as shown in FIGS. 1-2, the 360-degree rotational cam hydraulic door closer for the narrow frame door further includes an automatic compensation valve assembly 700 slidingly disposed in the inner chamber 110 and located at the left side of the eccentric cam 210. The automatic compensation valve assembly 700 and the bidirectional piston 300 collectively partition the inner chamber 110 into a first oil channel 810 located at the left side of the automatic compensation valve assembly 700, a second oil channel 820 located at the right side of the bidirectional piston 300, and a third oil channel 830 located between the automatic compensation valve assembly 700 and the bidirectional piston 300. The first oil channel 810, the second oil channel 820 and the third oil channel 830 are all filled with hydraulic oil. The hydraulic oil flows between the second oil channel 820 and the third oil channel 830 through the bidirectional piston 300, and the automatic compensation valve assembly 700 is configured in a way that if the pressure in the first oil channel 810 exceeds a threshold pressure, the automatic compensation valve assembly 700 allows the hydraulic oil to flow between the first oil channel 810 and the third oil channel 830.

Specifically, in this embodiment, the first oil channel 810, the second oil channel 820 and the third oil channel 830 are all filled with hydraulic oil. The door closer housing 100 can rotate along with the rotation of the door body, so as to change the position of the bidirectional piston 300 on the cam shaft 200, thereby changing the volume of the second oil channel 820. Then, the hydraulic oil flows between the second oil channel 820 and the third oil channel 830, resulting in a pressure difference between the first oil channel 810 and the third oil channel 830. That changes the status of the automatic compensation valve assembly 700 to cause the hydraulic oil corresponding flowing between the first oil channel 810 and the third oil channel 830 to balance the pressure difference between the first oil channel 810 and the third oil channel 830. That is, the hydraulic oil in the first oil channel 810, the second oil channel 820 and the third oil channel 830 can flow in coordination with the action of the door body.

The other parts of this embodiment are the same with the first embodiment. The features unexplained in this embodiment all adopt the explanation in the first embodiment, not repeatedly described here.

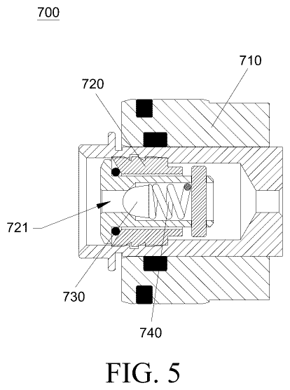

In an eighth embodiment of the present invention, as shown in FIG. 5, the automatic compensation valve assembly 700 includes:
a valve piston 710, the valve piston 710 being slidingly disposed in the inner chamber 110;
a valve body 720, the valve body 720 being installed in the valve piston 710, at the same time the valve body 720 being provided therethrough with a valve flow channel 721 communicating with the first oil channel 810 and the third oil channel 830;
a valve core member 730, the valve core member 730 being movably disposed in the valve flow channel 721 for realizing the open or shut of the valve flow channel 721; and
a valve core spring 740, the valve core spring 740 being accommodated in the valve flow channel 721, an end of the valve core spring 740 being connected with the valve body 720, another end of the valve core spring 740 being connected with the valve core member 730 for driving the valve core member 730 to shut off the valve flow channel 721.

Specifically, in this embodiment, the movement of the valve core member 730 can realize the open or shut of the valve flow channel 721. The disposal of the valve core spring 740 can ensure the accuracy of the movement of the valve core member 730. When the first oil channel 810 and the third oil channel 830 have a pressure difference therebetween, it can push the valve core member 730 to overcome the elastic force of the valve core spring 740 so as to move in the valve flow channel 721 to realize the open of the valve flow channel 721. After the pressure difference between the first oil channel 810 and the third oil channel 830 is balanced, the valve core member 730 is pushed by the elastic force of the valve core spring 740 to restore its position by moving in the valve flow channel 721, thereby realizing the shut of the valve flow channel 721. The status of the automatic compensation valve assembly 700 is automatically changed, and the reliability is high.

The other parts of this embodiment are the same with the seventh embodiment. The features unexplained in this embodiment all adopt the explanation in the seventh embodiment, not repeatedly described here.

The above description is only the preferred embodiments of the present invention, not intended to limit the present invention. Any modification, equivalent substitution and improvement made within the spirit and principle of the present invention should be included within the claimed scope of the present invention.

What is claimed is:

1. A 360-degree rotational cam hydraulic door closer for a narrow frame door, the 360-degree rotational cam hydraulic door closer comprising:
a door closer housing, the door closer housing being provided therein along an axis direction thereof with an inner chamber;
a cam shaft, an axial direction of the cam shaft being perpendicular to an extending direction of the door closer housing, the cam shaft being 360-degree rotatably supported in the door closer housing, the cam shaft being equipped at a middle part thereof with an eccentric cam rotating simultaneously with the cam shaft;
a bidirectional piston, the bidirectional piston being slidingly disposed in the inner chamber and located at a right side of the eccentric cam, a damping roller being rotationally disposed at a side of the bidirectional piston close to the eccentric cam; and
a drive spring, the drive spring being accommodated in the inner chamber and abutted against the bidirectional piston and the door closer housing, the drive spring driving the damping roller to be consistently flexibly abutted against an outer peripheral surface of the eccentric cam;
wherein the outer peripheral surface of the eccentric cam is provided clockwise in order with a left closing arc recess, an upper damping protrusion, a right closing arc recess and a lower damping protrusion; the left closing arc recess and the right closing arc recess are located on a same horizontal line; the upper damping protrusion and the lower damping protrusion are located on a same vertical line.

2. The 360-degree rotational cam hydraulic door closer as claimed in claim 1, wherein the bidirectional piston is equipped at the side thereof close to the eccentric cam with a fixed pin; the damping roller is rotationally installed on the fixed pin.

3. The 360-degree rotational cam hydraulic door closer as claimed in claim 1, wherein the drive spring comprises an inner spring and an outer spring; the outer spring is sleeved outside the inner spring; an end of the outer spring and the inner spring are abutted against the door closer housing at the same time; another end of the outer spring and the inner spring are abutted against the bidirectional piston at the same time.

4. The 360-degree rotational cam hydraulic door closer as claimed in claim 1, wherein the door closer housing is equipped with a first bushing correspondingly to a lower end of the cam shaft; the door closer housing is equipped with a positionally limiting installation seat correspondingly to an upper end of the cam shaft, and at the same time the positionally limiting installation seat is equipped with a second bushing; midpoints of the first bushing and the second bushing are located on a same axis; the cam shaft is inserted in the first bushing and the second bushing.

5. The 360-degree rotational cam hydraulic door closer as claimed in claim 4, wherein an outer sealing ring is disposed between an outer end surface of the positionally limiting installation seat and the door closer housing; an inner sealing ring is disposed between an inner end surface of the positionally limiting installation seat and the cam shaft.

6. The 360-degree rotational cam hydraulic door closer as claimed in claim 1, wherein the door closer housing comprises:
a housing main body, the housing main body being hollow inside and having two lateral openings, the cam shaft being pivoted to the housing main body; and
two sealing end caps, the two sealing end caps being fixedly disposed on the two lateral openings of the housing main body respectively to form the inner chamber in an enclosed manner, an end cap sealing ring being disposed between an outer end surface of the sealing end cap and the housing main body.

7. The 360-degree rotational cam hydraulic door closer as claimed in claim 1, wherein the 360-degree rotational cam hydraulic door closer further comprises an automatic compensation valve assembly slidingly disposed in the inner chamber and located at a left side of the eccentric cam; the automatic compensation valve assembly and the bidirectional piston collectively partition the inner chamber into a first oil channel located at a left side of the automatic compensation valve assembly, a second oil channel located at a right side of the bidirectional piston, and a third oil channel located between the automatic compensation valve assembly and the bidirectional piston; the first oil channel, the second oil channel and the third oil channel are all filled with hydraulic oil; the hydraulic oil flows between the second oil channel and the third oil channel through the bidirectional piston, and the automatic compensation valve assembly is configured in a way that if pressure in the first oil channel exceeds a threshold pressure, the automatic compensation valve assembly allows the hydraulic oil to flow between the first oil channel and the third oil channel.

8. The 360-degree rotational cam hydraulic door closer as claimed in claim 7, wherein the automatic compensation valve assembly comprises:
a valve piston, the valve piston being slidingly disposed in the inner chamber;
a valve body, the valve body being installed in the valve piston, at the same time the valve body being provided therethrough with a valve flow channel communicating with the first oil channel and the third oil channel;
a valve core member, the valve core member being movably disposed in the valve flow channel for realizing open or shut of the valve flow channel; and
a valve core spring, the valve core spring being accommodated in the valve flow channel, an end of the valve core spring being connected with the valve body, another end of the valve core spring being connected with the valve core member for driving the valve core member to shut off the valve flow channel.
